(19) United States
(12) Patent Application Publication
(10) Pub. No.: US 2011/0084846 A1
(43) Pub. Date: Apr. 14, 2011

(54) Electromagnetic Whiteboard Pen

(75) Inventors: Chih-Jen Li, Hsin-Chu (TW); Yan-Chin Hsu, Hsin-Chu (TW); Cheng-Lu Liu, Hsin-Chu (TW)

(73) Assignee: WALTOP INTERNATIONAL CORPORATION, Hsin-Chu (TW)

(21) Appl. No.: 12/617,718

(22) Filed: Nov. 12, 2009

(30) Foreign Application Priority Data
Oct. 13, 2009 (TW) 098218843

(51) Int. Cl. G08B 21/00; G06F 3/033; B43K 29/00

(52) U.S. Cl. 340/636.15; 345/179; 340/636.1; 401/195

(57) ABSTRACT

An electromagnetic whiteboard pen is disclosed, and particular an electromagnetic whiteboard pen capable of inking and digital inputting simultaneously is disclosed. The electromagnetic whiteboard pen has a marker for writing with ink and a coil for emitting electromagnetic signals. When user writes on an electromagnetic whiteboard by the marker, the coil emitting electromagnetic signals simultaneously. The electromagnetic whiteboard senses the electromagnetic signals to find and record the position and the moving of the electromagnetic whiteboard pen. Therefore, the writing on the electromagnetic whiteboard by inking can be record and converted to be digital signals for storing by the electromagnetic whiteboard when the electromagnetic whiteboard pen writes on the electromagnetic whiteboard.

### FIELD OF THE INVENTION

The present invention relates to an electromagnetic whiteboard pen, and particularly relates to an electromagnetic whiteboard pen capable of inking and digital inputting simultaneously.

### BACKGROUND OF THE INVENTION

A conventional electric whiteboard is a whiteboard capable of rolling the writing surface to the backside of the conventional electric whiteboard for scanning. Users write on the conventional electric whiteboard by a conventional whiteboard pen which can output ink but can not emit electromagnetic signals. The conventional whiteboard pen outputs ink to write on the writing surface of the conventional electric whiteboard. And then, the writing surface is rolled to the backside of the conventional electric whiteboard and scanned by a scanner on the backside of the conventional electric whiteboard. After scanning, the information written on the writing surface is stored in a memory device or printed by a printer.

However, with the development of the electric whiteboard, the electromagnetic induction technique is applied to the electric whiteboard largely and the electromagnetic whiteboard, which inputs the information written thereon by the electromagnetic induction technique and digitizes the information to be stored, is developed. The conventional whiteboard pen which writes on the electric whiteboard with ink is insufficient to use on the electromagnetic whiteboard because the electromagnetic whiteboard need to induce the electromagnetic signals for recording the positions and the moving trace of the whiteboard pen. The conventional whiteboard pen only can output ink to write on the electromagnetic whiteboard like write on the conventional electric whiteboard, but the conventional whiteboard pen can not input the information written on the electromagnetic whiteboard into the electromagnetic whiteboard and digitize information to be stored in the electromagnetic whiteboard simultaneously when the conventional whiteboard pen outputs ink to write on the electromagnetic whiteboard. It is because the conventional whiteboard can not emit the electromagnetic signals for the electromagnetic whiteboard to record the positions and moving trace of the conventional whiteboard pen.

Therefore, in view of foregoing drawbacks of conventional whiteboard pen, there is a need to provide an electromagnetic whiteboard pen capable of inking and digital inputting simultaneously. This electromagnetic whiteboard pen can be applied to the electromagnetic whiteboard, and when the electromagnetic whiteboard pen outputs ink to write on the electromagnetic whiteboard, the information written on the electromagnetic whiteboard is converted into the digital information to be stored simultaneously.

### SUMMARY OF THE INVENTION

An objective of this invention is to provide an electromagnetic whiteboard pen capable of being applied to the electromagnetic whiteboard. The electromagnetic whiteboard pen has the functions of writing with ink (inking input) and digital input. When the electromagnetic whiteboard pen writes on the electromagnetic whiteboard, the information written on the electromagnetic whiteboard by ink is inputted to the electromagnetic whiteboard by digital input and the information is converted into the digital information to be stored.

In one embodiment of the present invention, an electromagnetic whiteboard pen is disclosed and this electromagnetic whiteboard pen is capable of inking and digital inputting simultaneously. The electromagnetic whiteboard pen comprises a marker, a hollow penholder, a coil, a cover and a lid. The marker has an output head for outputting ink to write on an electromagnetic whiteboard. The hollow penholder is used for containing the marker and one end of the hollow penholder has a pen point member. The coil is deposed in the pen point member and the coil surrounds the output head of the marker for emitting a first electromagnetic signal or a second electromagnetic signal. The cover is used for covering and protecting the output head and the pen point member when the electromagnetic whiteboard pen is not used or operated. The lid is deposed at one end of the hollow penholder for fixing and sealing the marker in the hollow penholder. When the electromagnetic whiteboard pen outputs the ink to write on the electromagnetic whiteboard by the output head of the marker, the electromagnetic whiteboard pen emits the electromagnetic signals to the electromagnetic whiteboard by the coil simultaneously. Therefore, the electromagnetic whiteboard induces the electromagnetic signals and records the positions and the moving trace of the electromagnetic whiteboard pen by this induction, and then, the information written on the electromagnetic whiteboard is converted into the digital information to be stored.

Therefore, the effect achieved with the present invention is to provide an electromagnetic whiteboard pen. The electromagnetic whiteboard pen is capable of inking and digital inputting simultaneously. Therefore, when the electromagnetic whiteboard pen writes on the electromagnetic whiteboard, the information written on the electromagnetic whiteboard is inputted into the electromagnetic whiteboard by digital input and the information is converted into the digital information to be stored.

### BRIEF DESCRIPTION OF THE DRAWINGS

FIGS. 1A, 1B and 1C are stereoscopic form diagrams respectively illustrating an electromagnetic whiteboard pen in different states in accordance with one embodiment of the present invention.

FIG. 2A is a perspective form diagram illustrating the pen point member of the electromagnetic whiteboard pen in accordance with one embodiment of the present invention.

FIGS. 2B and 2C are a plan view diagram and a cross-sectional view diagram respectively illustrating the cover of the electromagnetic whiteboard pen in accordance with one embodiment of the present invention.

FIG. 2D is an exploded diagram illustrating the lid of the electromagnetic whiteboard pen in accordance with one embodiment of the present invention.

### DESCRIPTION OF THE EXEMPLARY EMBODIMENTS

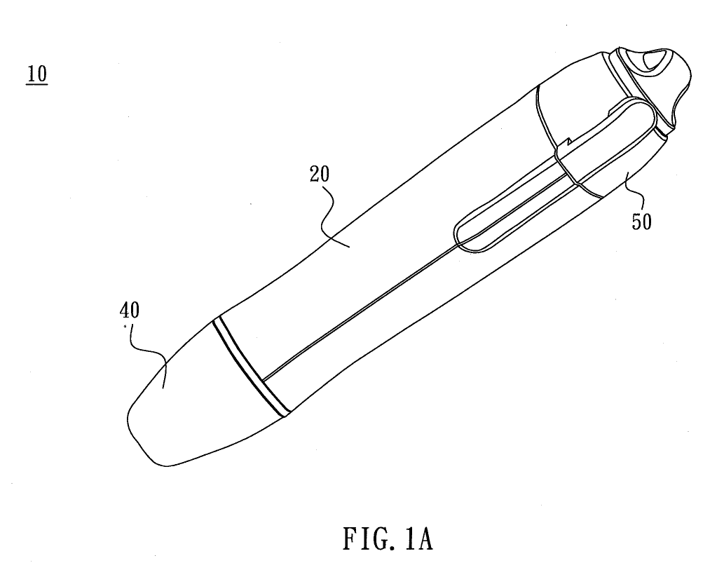

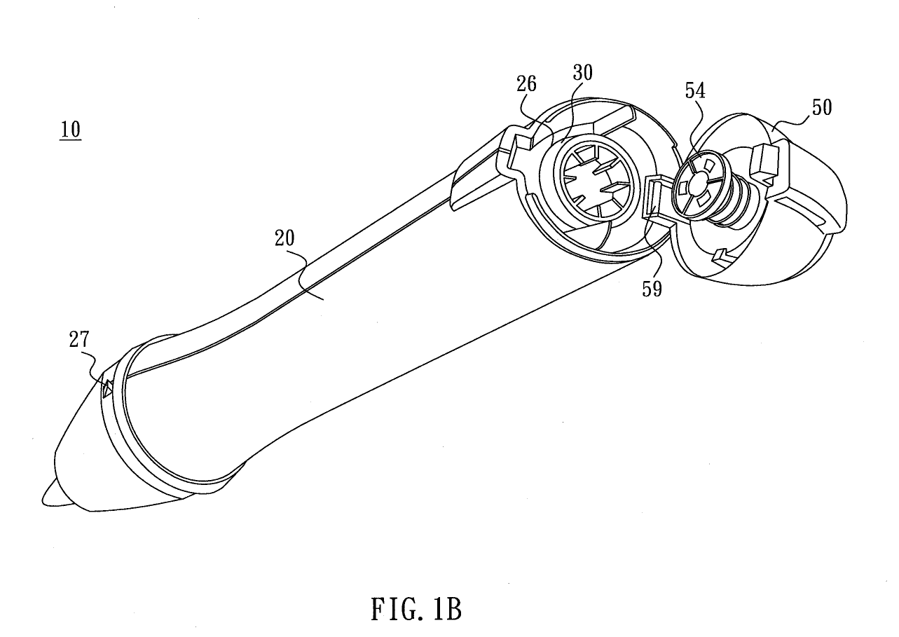

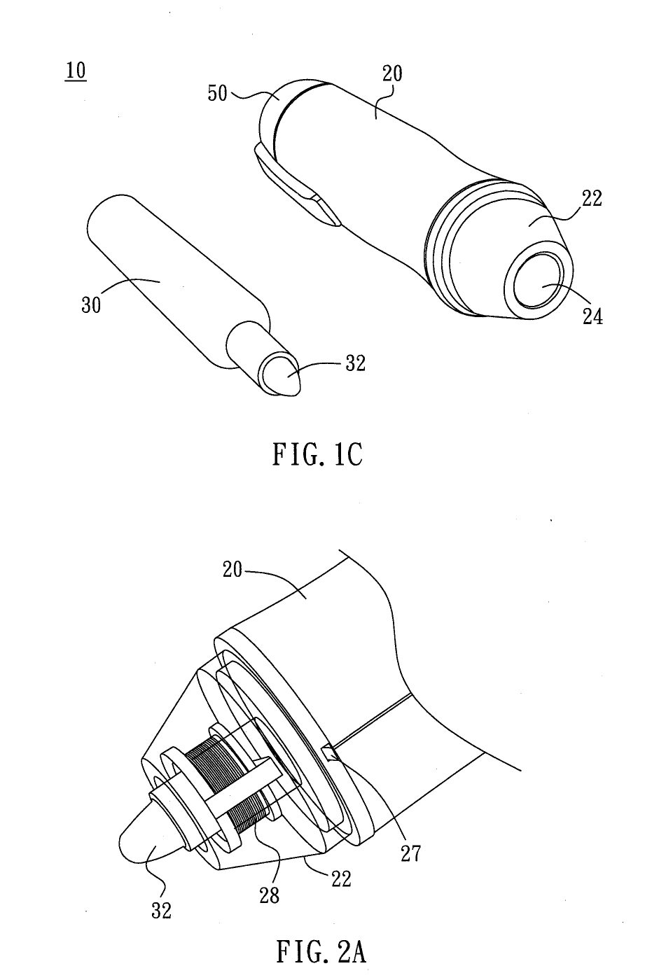

Referring to FIGS. 1A, 1B and 1C, they are respectively are stereoscopic form diagrams respectively illustrating an electromagnetic whiteboard pen 10 in different states in accordance with one embodiment of the present invention. FIG. 1A illustrates the electromagnetic whiteboard pen 10 in the state that the electromagnetic whiteboard pen 10 is not used. FIG. 1B illustrates the electromagnetic whiteboard pen 10 in the state that the cover 40 and the lid 50 are opened. FIG. 1C illustrates the electromagnetic whiteboard pen 10 in the state that the marker 30 is taken out from the electromagnetic whiteboard pen 10. Besides, FIGS. 1A, 1B and 1C also can be the diagrams illustrating the process for changing the marker 30 in the electromagnetic whiteboard pen 10 step by step.

The electromagnetic whiteboard pen 10 has a hollow penholder 20, a marker 30, a coil 28, a cover 40 and a lid 50, and the electromagnetic whiteboard pen 10 is made by foregoing members. The marker 30 has an output head 32 for outputting ink to write on a whiteboard. Therefore, the electromagnetic whiteboard pen 10 can write on the electromagnetic whiteboard by the ink to form inky writing on the electromagnetic whiteboard as the conventional whiteboard pen writes on the conventional electric whiteboard.

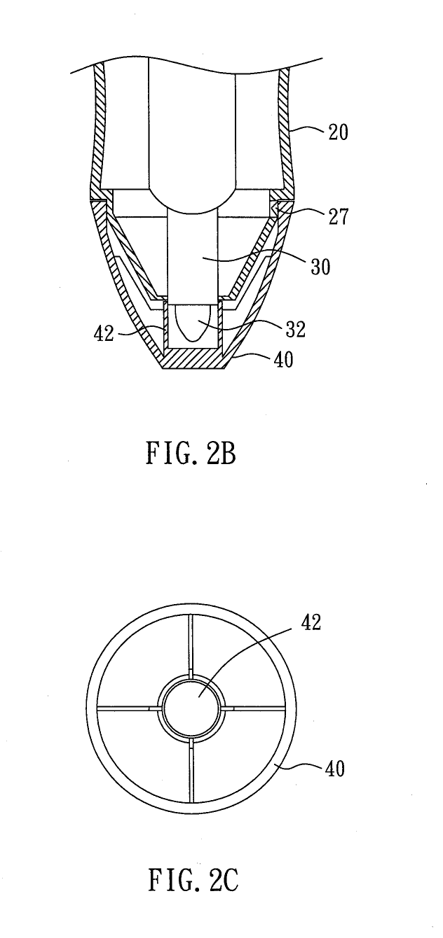

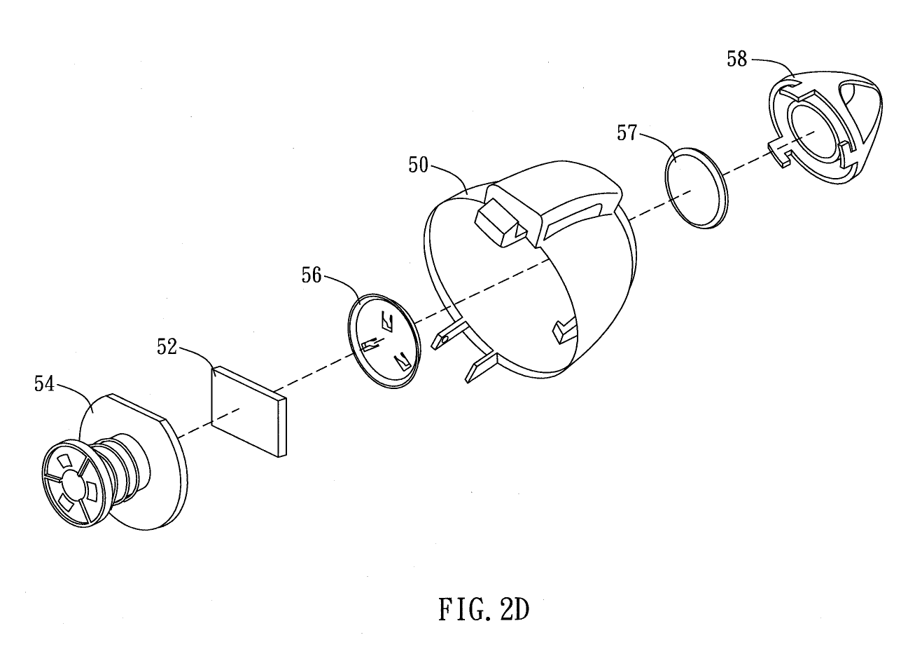

The hollow penholder 20 is the main body of the electromagnetic whiteboard pen for users to hold and use, and one end of the hollow penholder 20 has a pen point member 22. The coil 28 is deposed in the pen point member 22, and the coil 28 surrounds output head 32 of the marker 30 to be deposed inside the pen point member 22 (as FIG. 2A shows). The coil 28 is used for emitted a first electromagnetic signal or a second electromagnetic signal for electromagnetic induction of the electromagnetic whiteboard. Therefore, when the electromagnetic whiteboard pen 10 outputs ink to write on the electromagnetic whiteboard, the positions and the moving trace of the electromagnetic whiteboard pen 10 are recorded. And when writing on the electromagnetic whiteboard with ink, the information (or the inky writing or the writing) written on the electromagnetic whiteboard is inputted to the electromagnetic whiteboard by digital input (or by the electromagnetic induction) and the information is digitized or converted into the digital information to be stored. The first electromagnetic signal is an original electromagnetic signal emitted by the electromagnetic whiteboard pen 10, and the second electromagnetic signal is a writing electromagnetic signal defined by the electromagnetic whiteboard. The first electromagnetic signal and the second electromagnetic signal have different frequencies. Only when the electromagnetic whiteboard detects the second electromagnetic signal, the electromagnetic whiteboard will record the positions and the moving trace of the electromagnetic whiteboard pen 10.

Furthermore, the pen point member 22 of the hollow penholder 20 has a first opening 24 for passing the output head 32 of the marker 30 through the first opening 24. Therefore, the output head 32 is exposed from the hollow penholder 20 for conveniently writing when the marker 30 is placed into the hollow penholder 20. The diameter of the first opening 24 is larger than the diameter of the output head 32 for passing the output head 32 through the first opening 24 and exposing the output head 24 from the pen point member 22, but the diameter of the first opening 24 is smaller than the diameter of marker 30 for preventing the marker 30 from passing through the first opening 24 fully. Another end of the hollow penholder 20 (the end of the hollow penholder 20 without the pen point member 22) has a second opening 26 for placing the marker 30 into the hollow penholder 20 or changing the marker 30 in the hollow penholder 20. Therefore, the diameter of the second opening 26 is larger than the diameter of the marker 30 for placing and changing the marker 30 conveniently.

Besides, a power-saving switch 27 is deposed on the pen point member 22 for shutting down the electromagnetic whiteboard pen 10 to stop emitting the electromagnetic signals when the electromagnetic whiteboard pen 10 is not used. When the cover 40 and the hollow penholder 20 are closed, the cover 40 pushes or presses the power-saving switch 27 to turn on the power-saving switch 27 for controlling the coil 28 to stop emitting the electromagnetic signals. When the cover 40 is opened, the cover 40 does not push or press the power-saving switch 27 again and the power-saving switch 27 returns to the original position of the power-saving switch 27. Therefore, the power-saving switch 27 is turned off for controlling the coil 28 to start emitting the electromagnetic signals again.

The cover 40 is used to cover and protect the pen point member 22 of the hollow penholder 20 and the output head 32 of the marker 30 when the electromagnetic whiteboard pen 10 is not used. Referring to FIGS. 2B and 2C, they are respectively a plan view diagram and a cross-sectional view diagram illustrating the cover 40 of the electromagnetic whiteboard pen 10 in accordance with one embodiment of the present invention. A sealing member 42 is deposed in the cover 40 for sealing the output head 32 in the sealing member 42. When the cover 40 and the hollow penholder 20 are closed, a sealed space is formed by the sealing member 42 and the pen point member 22 to seal the output head 32 in this sealed space for preventing the ink from exposing in the air and volatilizing form the output head 32.

The lid 50 is deposed at one end of the hollow penholder 20 (the end of the hollow penholder 20 without the pen point member 22) for fixing and sealing the marker 30 in the hollow penholder 20 and for sealing the end of the hollow penholder 20 (the end of the hollow penholder 20 without the pen point member 22). The lid 50 is a cover capable of being opened and closed, and it is connected with the hollow penholder 20 by a connecting member 59 for controlling the lid 50 to open or close (as FIG. 1B shows). Referring to FIG. 2D, it is an exploded diagram illustrating the lid of the electromagnetic whiteboard pen in accordance with one embodiment of the present invention. The lid 50 comprises a control board 52 deposed therein, a writing switch 54 deposed under the control board 52, and a battery container 56 deposed on the control board 52.

The control board 52 is used for controlling the electromagnetic whiteboard pen 10 to operate or work, for example emit the electromagnetic signals, converting the frequency of the electromagnetic signal emitted by the electromagnetic whiteboard pen 10, and detecting the state of voltage or charge of the battery 57. The control board 52 has an oscillating circuit (it is not show in drawings) and a detecting circuit therein. The oscillating circuit is used for controlling the coil 28 to emit the electromagnetic signals, such as the first electromagnetic signal or the second electromagnetic signal. The detecting circuit is used for detecting the state of voltage or charge of the battery 57.

The writing switch 54 is used for converting the first electromagnetic signal to the second electromagnetic signal and for converting the second electromagnetic signal to the first electromagnetic signal so the frequency of the electromagnetic signal emitted by coil 28 is controlled to be converted between the frequencies of the first electromagnetic signal and the second electromagnetic signal. When the electromagnetic whiteboard pen 10 writes on the electromagnetic whiteboard, the output head 32 contacts the electromagnetic whiteboard and outputs ink to write. At this time, the output head 32 is pressed to bring the marker 30 back to push or press the writing switch 54, and then, the writing switch 54 converts the electromagnetic signal emitted from the coil 28 from the first electromagnetic signal to the second electromagnetic signal. The second electromagnetic signal is the writing electromagnetic signal defined by the electromagnetic whiteboard. Therefore, when the electromagnetic whiteboard induces the second electromagnetic signal, the electromagnetic whiteboard starts to record the positions and the moving trace of the electromagnetic whiteboard pen 10. By this way, the information, for example words, drawings, or pattern, written on the writing surface of the electromagnetic whiteboard by the electromagnetic whiteboard pen 10 is inputted to the electromagnetic whiteboard with hand, and the information is converted to the digital information for being stored. When the electromagnetic whiteboard pen 10 moves away from the writing surface of the electromagnetic whiteboard, the output head 32 is no longer pressed. Therefore, output head 32 brings the marker 30 to return to the original position of the marker 30, and the output head 32 no longer pushes or presses the writing switch 54 to turn off the writing switch 54 for converting the electromagnetic signal emitted by the coil 28 from the second electromagnetic signal to the first electromagnetic signal. The electromagnetic whiteboard does not record the positions and the moving trace of the electromagnetic whiteboard pen 10 any more because the first electromagnetic signal is not the writing electromagnetic signal defined by the electromagnetic whiteboard. Therefore, when the electromagnetic whiteboard pen 10 writes on the electromagnetic whiteboard with ink, the electromagnetic whiteboard pen 10 also emits the second electromagnetic signal and the electromagnetic whiteboard induces the second electromagnetic signal for recording the positions and the moving trace of the electromagnetic whiteboard pen 10. By this way, the information written on the electromagnetic whiteboard by the output head 32 of the electromagnetic whiteboard pen 10 are inputted in the electromagnetic whiteboard at the same time, and the information is converted into the digital information to be stored.

The battery container 56 is deposed in the lid 50 for containing a battery 57 to be a power supply of the electromagnetic whiteboard pen 10. The lid 50 has a battery cover 58 capable of being opened and closed for sealing the battery 57 in the lid 50 and for changing the battery 57. Furthermore, a low power indicator is deposed in the lid 50 or on one surface of the lid 50 for giving an alarm when the power of the battery 57 is low. When the detecting circuit deposed on the control board 52 detects that the voltage or the charge of the battery 57 is in low state, the detecting circuit notifies the low power indicator to give an alarm for reminding the user to change the battery 57 when the voltage or the charge of the battery 57 is in low state. By this way, both of the situation that the electromagnetic whiteboard pen 10 can not emit the electromagnetic signals caused by the low state of the voltage or the charge of the battery 57 and the situation that the information written on the electromagnetic whiteboard can not be recorded and stored by the electromagnetic whiteboard can be avoided when the electromagnetic whiteboard pen 10 writes on the electromagnetic whiteboard. The low power indicator is a LED or other indicator capable of emitting light or voice.

The electromagnetic whiteboard pen of this invention outputs ink to write by marker and emits the electromagnetic signals by the coil simultaneously when the electromagnetic whiteboard pen writes on the electromagnetic whiteboard. Therefore, the electromagnetic whiteboard induces the electromagnetic signals emitted by the coil to record the positions and the moving trace of the electromagnetic whiteboard pen on the writing surface of the electromagnetic whiteboard, and they are recorded in the electromagnetic whiteboard for inputting the information in digital form. By this way, the writing and the information, which the marker of the electromagnetic whiteboard pen outputs ink to write on the writing surface of the electromagnetic whiteboard, are converted into the digital information and stored in the electromagnetic whiteboard. Furthermore, the electromagnetic whiteboard pen of this invention can stop emitting the electromagnetic signals automatically for power saving when the electromagnetic whiteboard pen is not used or operated. It is because a power-saving switch is deposed on the pen point member of the electromagnetic whiteboard pen for controlling the coil to start or stop emitting the electromagnetic signals. A low power indicator is deposed in the lid or on one surface of the lid for giving an alarm when the power of the battery is low. Therefore, the low power indicator reminds the user to change the battery for avoiding both of the situation that the electromagnetic whiteboard pen 10 can not emit the electromagnetic signals because of the low power of the battery and the situation that the information written on the electromagnetic whiteboard can not be recorded and stored by the electromagnetic whiteboard because of the low power of the battery. Therefore, this invention provides an electromagnetic whiteboard pen capable of being applied to the electromagnetic whiteboard, inking and digital inputting simultaneously, saving power and having a low power indicator.

Although the present invention will be described in accordance with the embodiments shown above, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An electromagnetic whiteboard pen, comprising:
a marker having an output head for outputting ink to write on an electromagnetic whiteboard;
a hollow penholder for containing said marker wherein one end of said hollow penholder has a pen point member;
a coil deposed in said pen point member and surrounding said output head of said marker for emitting a first electromagnetic signal or a second electromagnetic signal;
a cover for covering and protecting said output head and said pen point member when said electromagnetic whiteboard pen is not used or operated; and
a lid deposed at one end of said hollow penholder for fixing and sealing said marker in said hollow penholder.

2. The electromagnetic whiteboard pen of claim 1, wherein said pen point member of said hollow penholder has a first opening for passing said output head of said marker through said first opening to expose said output head from said hollow penholder for writing.

3. The electromagnetic whiteboard pen of claim 2, wherein another end of said hollow penholder has a second opening for putting said marker into said hollow penholder or for changing said marker in said hollow penholder.

4. The electromagnetic whiteboard pen of claim 3, wherein diameter of said first opening is larger than diameter of said output head of said marker for passing said output head of said marker through said first opening and exposing said output head from said hollow penholder, and said diameter of said first opening is smaller than diameter of said marker for preventing said marker from passing through said first opening fully.

5. The electromagnetic whiteboard pen of claim 4, wherein diameter of said second opening is larger than diameter of said marker for placing and changing said marker conveniently.

6. The electromagnetic whiteboard pen of claim 1, wherein a power-saving switch is deposed on said pen point member, and said cover pushes or presses said power-saving switch to turn on said power-saving switch for controlling said coil to stop emitting said electromagnetic signals when said cover and hollow penholder are closed.

7. The electromagnetic whiteboard pen of claim 1, wherein said cover does not push or press said power-saving switch to turn off said power-saving switch for controlling said coil to start emitting said electromagnetic signals when said cover is opened.

8. The electromagnetic whiteboard pen of claim 1, wherein said lid is connected with said hollow penholder by a connecting member for controlling said lid to open or close.

9. The electromagnetic whiteboard pen of claim 8, wherein said first electromagnetic signal and said second electromagnetic signal have different frequencies, and said first electromagnetic signal is an original electromagnetic signal and said second electromagnetic signal is a writing electromagnetic signal.

10. The electromagnetic whiteboard pen of claim 9, wherein said lid comprising:
a control board for controlling said electromagnetic whiteboard pen to operate or work;
a writing switch deposed under said control board for converting said first electromagnetic signal to said second electromagnetic signal and for converting said second electromagnetic signal to said first electromagnetic signal; and
a battery container deposed on said control board for containing a battery to be a power supply of said electromagnetic whiteboard pen.

11. The electromagnetic whiteboard pen of claim 10, wherein when said electromagnetic whiteboard pen writes on an electromagnetic whiteboard, said output head is pressed to bring said marker back to push or press said writing switch, and then, said writing switch converts the electromagnetic signal emitted by said coil from said first electromagnetic signal to said second electromagnetic signal for said electromagnetic whiteboard to start recording positions and moving trace of said electromagnetic whiteboard pen.

12. The electromagnetic whiteboard pen of claim 11, wherein when said electromagnetic whiteboard pen moves away from said electromagnetic whiteboard, said output head returns to original position and said output head does not push or press said writing switch, and then, said writing switch converts the electromagnetic signal emitted by said coil from said second electromagnetic signal to said first electromagnetic signal.

13. The electromagnetic whiteboard pen of claim 10, wherein said lid further comprises a low power indicator deposed in said lid or on one surface of said lid for alerting the user when the power of said battery is low.

14. The electromagnetic whiteboard pen of claim 13, wherein said low power indicator is a LED.

15. The electromagnetic whiteboard pen of claim 13, wherein a detecting circuit is deposed in said control board for detecting the state of voltage or charge of said battery, and then, said detecting circuit notifies said low power indicator to give an alarm when the voltage of said battery or the charge of said battery is in low state.

16. The electromagnetic whiteboard pen of claim 10, wherein an oscillating circuit is deposed in said control board for controlling said coil to emit the electromagnetic signals.

17. The electromagnetic whiteboard pen of claim 10, wherein said lid further comprises a battery cover for sealing said battery in said lid and for changing said battery.

18. The electromagnetic whiteboard pen of claim 1, wherein a sealing member is deposed in said cover to seal said output head in said sealing member for preventing ink from volatilizing form said output head when said cover and said hollow penholder are closed.
